(19) United States
(12) Patent Application Publication
(10) Pub. No.: US 2014/0156849 A1
(43) Pub. Date: Jun. 5, 2014

(54) MAP-REDUCE WORKFLOW PROCESSING APPARATUS AND METHOD, AND STORAGE MEDIA STORING THE SAME

(71) Applicant: LG CNS CO., LTD., (US)

(72) Inventors: Ki Do Kim, Seoul (KR); Seok Keun Oh, Seoul (KR); Joo Youl Lee, Seoul (KR)

(21) Appl. No.: 13/866,710

(22) Filed: Apr. 19, 2013

(30) Foreign Application Priority Data
Nov. 30, 2012 (KR) 10-2012-0138477

(51) Int. Cl. H04L 29/08

(52) U.S. Cl. CPC H04L 29/0827
USPC 709/226

(57) ABSTRACT

A map-reduce workflow processing apparatus includes a workflow receiving unit configured to receive a plurality of the map-reduce workflows and a workflow control unit configured to use workflow metadata including a workflow execution definition of the plurality of the map-reduce workflows relation information among the plurality of the map-reduce workflows to control a workflow.

### CROSS-REFERENCE TO RELATED APPLICATION

This application claims priority under 35 U.S.C. §119 to Korean Patent Application No. 10-2012-0138477, filed on Nov. 30, 2012, in the Korean Intellectual Property Office, the contents of which are incorporated herein by reference.

### BACKGROUND OF THE INVENTION

1. Field of the Invention

The present invention relates to a workflow processing technique and, more particularly, to a map-reduce workflow processing apparatus and method, and storage media storing the same that may process a map-reduce workflow through a workflow metadata.

2. Background of the Invention

A map-reduce job includes a map job distributing an entire work on a plurality of servers and a reduce job gathering results of the map job to output a final result.

The Korean Patent Laid Open Publication No. 10-2011-0012867 relates to a distributed memory cluster control apparatus and method, using a map-reduce of mass data distributed processing as cloud computing system. A memory cluster management unit allocates the number of division storage areas. The memory cluster management unit sets up the number of reducers. A control unit designates a location of the division storage area based on memory cluster shape information. The control unit designates a location of the reducer based on the memory cluster shape information. A memory cluster shape storage unit stores the memory cluster shape information.

The Korean Patent Laid Open Publication No. 10-2011-0006691 relates to a packet analysis system using Hadoop based parallel arithmetic and method thereof are provided to rapidly process mass packet traces by analyzing and storing packet data in a Hadoop cluster environment.

These prior arts may have some problems due to just processing a single map-reduce work.

### SUMMARY OF THE INVENTION

A first aspect of the present invention describes a map-reduce workflow processing apparatus comprising: a workflow receiving unit configured to receive a plurality of the map-reduce workflows; and a workflow control unit configured to use workflow metadata including a workflow execution definition of the plurality of the map-reduce workflows relation information among the plurality of the map-reduce workflows to control a workflow.

A second aspect of the present invention describes a map-reduce workflow processing method performed by a map-reduce workflow processing apparatus comprising: receiving a plurality of the map-reduce workflows; and using workflow metadata including a workflow execution definition of the plurality of the map-reduce workflows and relation information among the plurality of the map-reduce workflows to control a workflow.

A third aspect of the present invention describes a storage media storing a computer program performed by a map-reduce workflow apparatus comprising: a function of receiving a plurality of the map-reduce workflows; and a function of using workflow metadata including a workflow execution definition of the plurality of the map-reduce workflows and relation information among the plurality of the map-reduce workflows to control a workflow.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram illustrating a map-reduce workflow processing apparatus according to an example embodiment of the present invention.

FIG. 2 is a diagram illustrating a workflow execution unit in FIG. 1.

FIG. 3 is a flowchart illustrating a procedure of updating call relation information in a workflow control unit and a workflow execution unit.

FIG. 4 is a diagram illustrating a workflow execution definition and workflow metadata.

FIG. 5 is a flowchart illustrating a pause procedure of a caller workflow according to a modification of a map-reduce workflow.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION OF THE EMBODIMENTS

Explanation of the present invention is merely an embodiment for structural or functional explanation, so the scope of the present invention should not be construed to be limited to the embodiments explained in the embodiment. That is, since the embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

Terms described in the present disclosure may be understood as follows.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Meanwhile, other expressions describing relationships between components such as “˜between”, “immediately˜between” or “adjacent to ˜” and “directly adjacent to ˜” may be construed similarly.

Singular forms “a”, “an” and “the” in the present disclosure are intended to include the plurality of forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Identification letters (e.g., a, b, c, etc.) in respective steps are used for the sake of explanation and do not described order of respective steps. The respective steps may be changed from a mentioned order unless specifically mentioned in context. Namely, respective steps may be performed in the same order as described, may be substantially simultaneously performed, or may be performed in reverse order.

In describing the elements of the present invention, terms such as first, second, A, B, (a), (b), etc., may be used. Such terms are used for merely discriminating the corresponding elements from other elements and the corresponding elements are not limited in their essence, sequence, or precedence by the terms.

In the embodiments of the present invention, the foregoing method may be implemented as codes that can be read by a processor in a program-recorded medium. The processor-readable medium may include any types of recording devices in which data that can be read by a computer system is stored. The processor-readable medium may include a ROM, a RAM, a CD-ROM, a magnetic tape, a floppy disk, an optical data storage apparatus, and the like. The processor-readable medium also includes implementations in the form of carrier waves or signals (e.g., transmission via the Internet). The computer-readable recording medium may be distributed over network-coupled computer systems so that the computer-readable code may be stored and executed in a distributed fashion.

In the foregoing exemplary system, the methods are described based on the flow chart as sequential steps or blocks, but the present invention is not limited to the order of the steps and some of them may be performed in order different from the order of the foregoing steps or simultaneously. Also, a skilled person in the art will understand that the steps are not exclusive but may include other steps, or one or more steps of the flow chart may be deleted without affecting the scope of the present invention.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

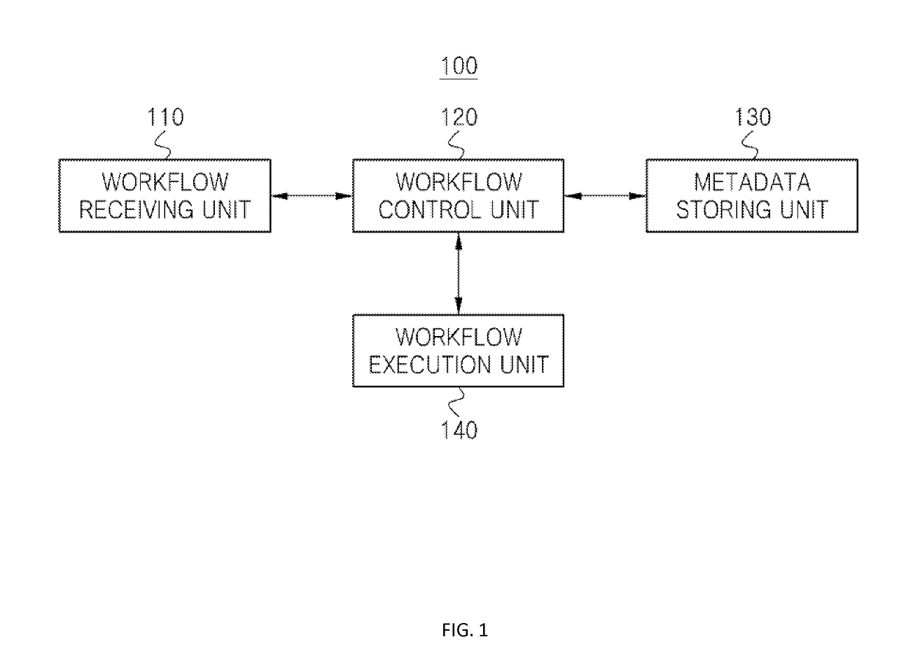

FIG. 1 is a diagram illustrating a map-reduce workflow processing apparatus according to an example embodiment of the present invention.

Referring to FIG. 1, a map-reduce processing apparatus 100 includes a workflow receiving unit 110, a workflow control unit 120, a workflow conversion unit 125, a metadata storing unit 130, and a workflow execution unit 140.

The workflow receiving unit 110 receives a plurality of map-reduce workflows. In one embodiment, the plurality of map-reduce workflows may be independent with each other. A map-reduce workflow may include at least one map-reduce job. The map-reduce workflow corresponds to a process for a series of jobs for processing mass data and may include at least one map-reduce job or individual map-reduce workflows as a called map-reduce workflow. Also, the map-reduce workflow includes a condition parameter for performing a branch job and in each of the branch job, individual map-reduce workflows may be performed. In one embodiment, the workflow receiving unit 110 may directly implement the map-reduce or may provide a user interface that can fetch one from other storage.

In one embodiment, the workflow receiving unit 110 may receive map-reduce application information. The map-reduce application information may be used for defining the map-reduce job as an external application (e.g., JAR file).

The workflow control unit 120 uses workflow metadata to control a map-reduce workflow. The workflow metadata includes a workflow definition of each of the plurality of the map-reduce workflows and relation information among the plurality of the map-reduce workflows. In one embodiment, the relation information may indicate an execution relation among at least one work process and call relation information indicating a call relation among the plurality of the map-reduce workflows. For example, the relation information may include an identifier of a first workflow and an identifier of a second workflow related with the first workflow. In one embodiment, the workflow control unit 120 may generate the relation information among the plurality of the map-reduce workflows. In one embodiment, when at least one of the plurality of the map-reduce workflows is modified, the workflow control unit 120 may control a related workflow based on related information of a modified workflow.

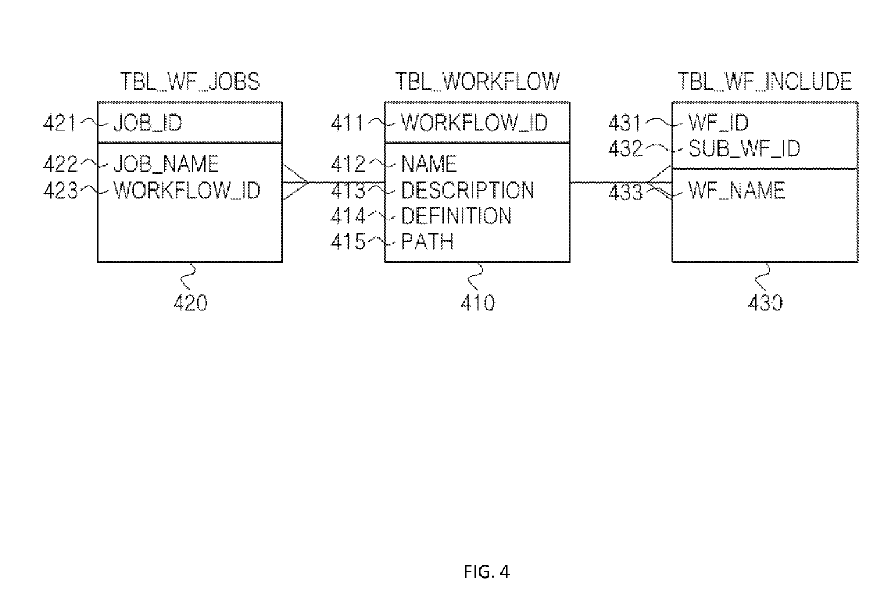

Herein, the workflow execution definition includes each of the plurality of the map-reduce jobs or the individual map-reduce workflows to determine a process of the workflow. In one embodiment, each of the plurality of the map-reduce jobs may correspond to a job received through the workflow receiving unit 110 or may correspond to a job added by the workflow control unit 120. Namely, the workflow control unit 120 adds jobs received through the workflow receiving unit 110 into an additional job to improve a mass data processing efficiency. A workflow metadata will be described with reference to FIG. 4.

The workflow conversion unit 125 converts the workflow execution definition and the relation information as a formal language. Herein, the formal language may correspond to a language interpreted by the map-reduce workflow processing apparatus 100 such as an XML language.

The metadata storing unit 130 stores the metadata and in one embodiment, may respectively store the workflow execution definition of each of the plurality of the map-reduce workflows and the relation information to tables. Herein, the tables may be implemented as database tables. The workflow control unit 120 may read or write the metadata in the metadata storing unit 130. Also, the workflow control unit 120 may modify or update the metadata in the metadata storing unit 130 when the workflow execution definition or the relation information is modified or updated.

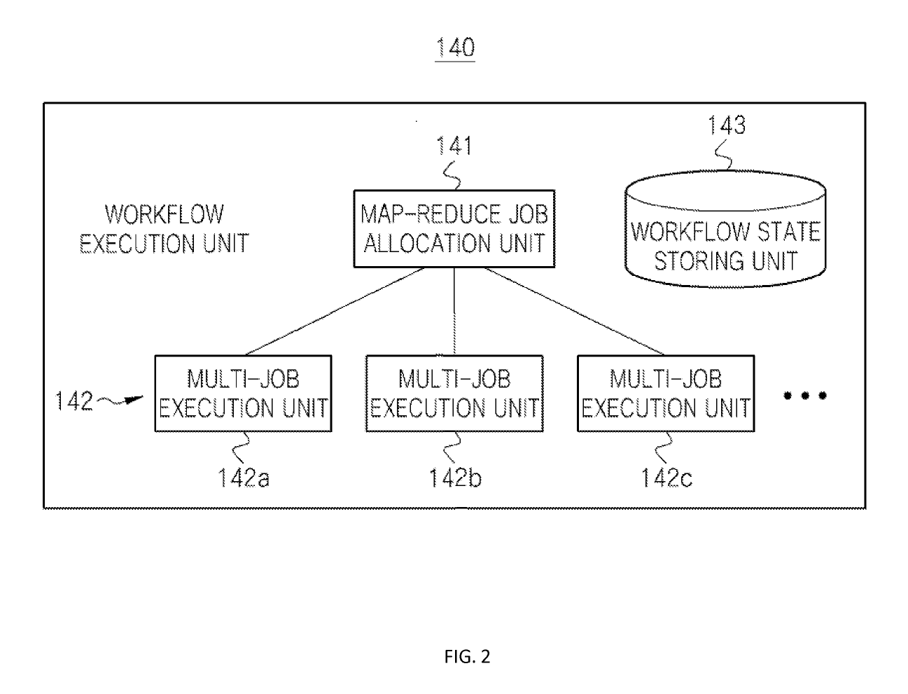

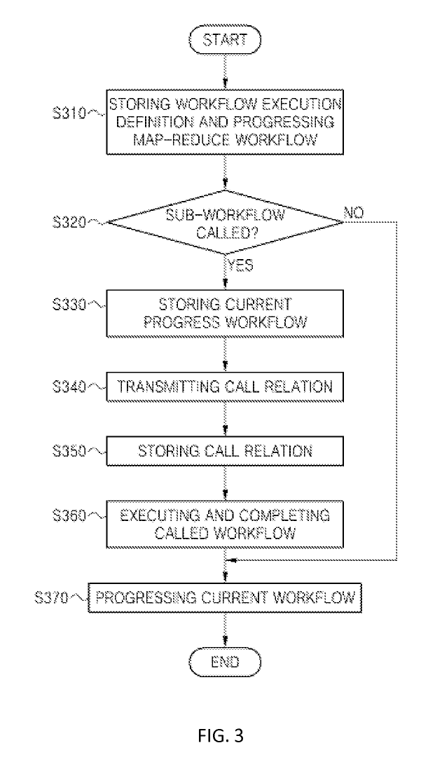

The workflow execution unit 140 executes the workflow execution definition. In one embodiment, the workflow execution unit 140 may be implemented as a map-reduce workflow engine and the map-reduce workflow engine, for example, may correspond to Oozie of Apache Foundation or Azkaban of Linked In. The workflow execution unit 140 will be described with reference to FIGS. 2 and 3.

FIG. 2 is a diagram illustrating a workflow execution unit in FIG. 1.

Referring to FIG. 2, the workflow execution unit 140 may include a map-reduce job performing unit 141, a map-reduce job allocation unit 142, and a workflow state storing unit 143. The map-reduce job performing unit 141 performs a map-reduce job defined in the workflow execution definition and the map-reduce allocation unit 142 allocates the map-reduce job and manages a job state of the map-reduce job performing unit 141.

The map-reduce job performing unit 141 may correspond to a computing node (hardware or software) capable of performing a map job and a reduce job included in the map-reduce job. For example, the map-reduce job performing unit 141 may be implemented as a task tracker of a Hadoop distributed system.

The map-reduce job allocation unit 142 allocates the map-reduce job into the map-reduce job performing unit 141 and manages the job states of the map-reduce job performing unit 141 to cause the map-reduce job performing unit 141 to process the mass data. For example, the map-reduce job allocation unit 142 may be implemented as a job tracker of the Hadoop distributed system.

A workflow state storing unit 143 stores execution states of the map-reduce workflow and the map-reduce job. In one embodiment, the workflow control unit 120 may determine whether a related workflow is being executed in the workflow execution unit 140 based on related information of a modified workflow when at least one of the plurality of the map-reduce workflows. Also, the workflow control unit 120 may control the related workflow according to whether the related workflow executes or not. Namely, when the workflow execution unit 140 pauses due to an unexpectedly internal or external signal, the workflow state storing unit 143 may store identifiers of the map-reduce workflow and a map-reduce job configuring a corresponding workflow or execution states of individually called map-reduce workflows. For example, the execution state may include a stand-by state, an execution state, a success state, a failure state. The workflow execution unit 140 may continually progress the map-reduce workflow from a specific point stored in the workflow state storing unit 143.

In one embodiment, the workflow execution unit 140 may store a progress state of a first map-reduce workflow into the workflow state storing unit 143 when a second map-reduce workflow is called from the first map-reduce workflow. The workflow execution unit 140 may continually progress the first map-reduce workflow from a point stored in the workflow state storing unit 143 after the job by the second map-reduce workflow is completed.

FIG. 3 is a flowchart illustrating a procedure of updating call relation information in a workflow control unit and a workflow execution unit.

The workflow control unit 120 and the workflow execution unit 140 may update the call relation information through following steps while executing the map-reduce workflow.

The workflow control unit 120 stores the workflow execution definition into the metadata storing unit 130 and controls the map-reduce workflow according to the workflow execution definition (Step S310). The workflow execution unit 140 stores a current state of the currently executed map-reduce workflow in the workflow state storing unit 143 when the currently executed map-reduce workflow calls another map-reduce workflow (Step 330).

The workflow execution unit 140 transmits a call relation to the workflow control unit 120 when the second map-reduce workflow is called from the first map-reduce workflow (Step S340).

The workflow control unit 120 updates the call relation information stored in the metadata storing unit 130 based on the received call relation (Step S350). The workflow control unit 120 continues to control the current workflow when the progress of the called workflow is completed (Step S370).

FIG. 4 is a diagram illustrating a workflow execution definition and workflow metadata.

The workflow execution definition 410 may include the plurality of the map-reduce jobs or individual map-reduce workflows and may determine the progress of the map-reduce workflow. In one embodiment, the workflow execution definition 410 may include at least one of an identifier 411, a name 412, a description attribute 413 and a purpose attribute 414 of the map-reduce workflow.

The job relation information 420 may indicate an execution relation among job processes and in one embodiment, may include an identifier 421 and name 422 of a job process and an access key 423 for a workflow identifier associated with a job process.

The call relation information 430 may indicate the call relation among the plurality of the map-reduce workflows and may include an access key 431 for a caller workflow, an access key 432 for a called work flow and a name of a workflow. Herein, when the map-reduce workflow calls another map-reduce workflow, a calling map-reduce workflow corresponds to the caller workflow and the called map-reduce workflow corresponds to a called workflow.

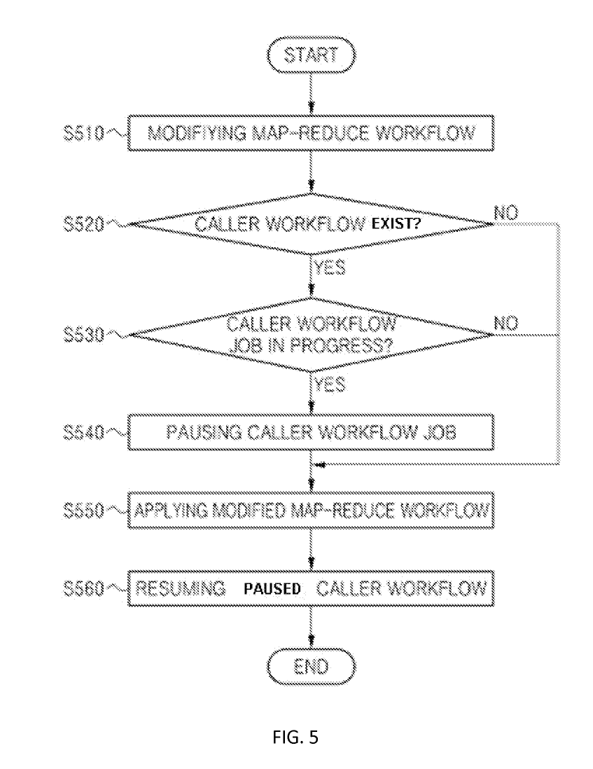

FIG. 5 is a flowchart illustrating a pause procedure of a caller workflow according to a modification of a map-reduce workflow.

The workflow control unit 120 may pause the caller workflow job calling a corresponding workflow when the map-reduce workflow is modified and applied.

When the map-reduce workflow is modified, there may be a caller workflow calling the modified map-reduce workflow (Steps S510 and S520). When a corresponding caller workflow is in progress, the workflow control unit 120 pauses a job of the caller workflow (Steps S530 and S540). Then, the workflow control unit 120 may apply the modified map-reduce workflow (Step S550) and may resume the paused caller workflow (Step S560). In one embodiment, the workflow control unit 120 may pause the caller map-reduce workflow as a state on the verge of a corresponding call when a currently executed map-reduce workflow is modified. The workflow control unit 120 may control a modified map-reduce workflow through the caller map-reduce workflow when the modification of the map-reduce workflow is completed.

In one embodiment, when the map-reduce workflow is modified, the workflow control unit 120 may refer to the modified map-reduce workflow or may provide the referred map-reduce workflow list to user notification screen.

Although this document provides descriptions of preferred embodiments of the present invention, it would be understood by those skilled in the art that the present invention can be modified or changed in various ways without departing from the technical principles and scope defined by the appended claims.

What is claimed is:

1. A map-reduce workflow processing apparatus comprising:
a workflow receiving unit configured to receive a plurality of the map-reduce workflows; and
a workflow control unit configured to use workflow metadata including a workflow execution definition of each of the map-reduce workflows and relation information among the map-reduce workflows to control the map-reduce workflows.

2. The map-reduce workflow processing apparatus of claim 1, wherein the workflow control unit generates the relation information among the map-reduce workflows

3. The map-reduce workflow processing apparatus of claim 1, wherein the workflow control unit controls a related workflow based on related information of a modified workflow when at least one of the plurality of the map-reduce workflows is modified.

4. The map-reduce workflow processing apparatus of claim 1, further comprising:
a workflow conversion unit configured to convert the workflow execution definition and the workflow metadata as a formal language.

5. The map-reduce workflow processing apparatus of claim 1, further comprising:
a metadata storing unit configured to respectively store the workflow execution definition of the plurality of the map-reduce workflows and the relation information to tables.

6. The map-reduce workflow processing apparatus of claim 1, further comprising:
a workflow execution unit configured to execute the workflow execution definition;
a map-reduce job performing unit configured to perform a map-reduce job defined in the workflow execution definition; and
map-reduce job allocation unit configured to allocate the map-reduce job and to manage a job state of the map-reduce job performing unit.

7. The map-reduce workflow processing apparatus of claim 6, further comprising:
workflow state storing unit configured to store execution states of the map-reduce workflow and the map-reduce job.

8. The map-reduce workflow processing apparatus of claim 6, wherein the workflow control unit determines whether a related workflow is being executed in the workflow execution unit based on related information of a modified workflow when at least one of the plurality of the map-reduce workflows and controls the related workflow according to whether the related workflow executes or not.

9. The map-reduce workflow processing apparatus of claim 1, wherein the relation information includes an identifier of a first workflow and an identifier of a second workflow related with the first workflow.

10. A map-reduce workflow processing method performed by a map-reduce workflow processing apparatus, the map-reduce workflow processing method comprising:
receiving a plurality of the map-reduce workflows; and
using workflow metadata including a workflow execution definition of each of the map-reduce workflows and relation information among the map-reduce workflows to control the map-reduce workflow.

11. The map-reduce workflow processing method of claim 13, wherein using workflow metadata comprises generating the relation information among the map-reduce workflows

12. The map-reduce workflow processing method of claim 11, wherein generating the relation information includes
calling a relation workflow related with the at least one workflow based on a workflow execution definition among the plurality of the map-reduce workflows;
storing metadata of the relation workflow into relation information of the at least one workflow.

13. The map-reduce workflow processing method of claim 10, wherein receiving a plurality of the map-reduce workflows comprises receiving a modified workflow, the modified workflow being generated by modifying the at least one workflow of the plurality of the map-reduce workflows and
using workflow metadata includes determining whether a relation workflow exists based on relation information of the modified workflow and completing an update of the modified workflow according to whether the relation workflow exists or not.

14. The map-reduce workflow processing method of claim 13, wherein the update of the modified workflow comprises:
when the relation workflow exists, determining whether the relation workflow is being executed;
when the relation workflow is being executed, pausing the relation workflow;
updating the modified workflow; and
executing the relation workflow.

15. The map-reduce workflow processing method of claim 10, further comprising converting the workflow execution definition and the relation information as a formal language.

16. The map-reduce workflow processing method of claim 10, further comprising respectively store the workflow execution definition of the plurality of the map-reduce workflows and the relation information to tables.

17. A storage media storing a computer program performed by a map-reduce workflow apparatus comprising:
a function of receiving a plurality of the map-reduce workflows; and
a function of using workflow metadata including a workflow execution definition of each of the map-reduce workflows and relation information among the map-reduce workflows to control a workflow.
